(19) United States
(12) Patent Application Publication
(10) Pub. No.: US 2006/0088375 A1
(43) Pub. Date: Apr. 27, 2006

(54) Welding joint of fuel tank

(75) Inventors: Takahiro Nishiyama, Kasugai-Shi (JP); Kensuke Sasai, Komaki-shi (JP); Kazutaka Katayama, Kasugai-shi (JP); Hiroaki Ito, Kasugai-shi (JP); Nobuaki Niki, Inuyama-shi (JP); Junichiro Suzuki, Kasugai-shi (JP)

Correspondence Address: DARBY & DARBY P.C., P. O. BOX 5257, NEW YORK, NY, 10150-5257, US

(73) Assignee: TOKAI RUBBER INDUSTRIES, LTD., Komaki-Shi (JP)

(21) Appl. No.: 11/255,257

(22) Filed: Oct. 21, 2005

(30) Foreign Application Priority Data
Oct. 22, 2004 (JP) 2004-308957
Jun. 30, 2005 (JP) 2005-192915

(51) Int. Cl. F16B 11/00

(52) U.S. Cl. 403/271; 403/270

(57) ABSTRACT

A welding joint has a cylindrical portion being a connection portion and an annular fusion-welded portion disposed at a base end part of the cylindrical portion, the fusion-welded portion being configured to be thermal fusion welded to a resin-made fuel tank. At least parts of the fusion-welded portion and the cylindrical portion are integrally molded by employing a resinous alloy material in which a modified high-density polyethylene obtained by introducing a functional group of high affinity to a hydroxyl group of ethylene-vinylalcohol copolymer is alloyed with the ethylene-vinylalcohol copolymer singly or together with high-density polyethylene.

### BACKGROUND OF THE INVENTION

1. Field of the Invention

This invention relates to a resin-made joint for connecting a piping tube or a connector to a resin-made fuel tank, and more particularly to a resin-made welding joint which is fusion-welded to a fuel tank so as to construct a connection portion.

2. Description of the Related Art

A fuel tank which is mounted on an automobile is integrally provided with a joint that serves to connect a tube, a connector or the like for introducing fuel poured from a filler opening, into the fuel tank.

Here, in case of, for example, the tube which introduces the fuel from the filler opening into the fuel tank, a rubber-made tube (rubber hose) has hitherto been employed. In recent years, however, the permeability of the fuel to the exterior through the hose has been severely regulated from the viewpoint of the preservation of the environment. Therefore, a rubber/resin compound tube in which the rubber hose further includes a barrier layer of resin, a rubber tube which is made of a fluorine rubber having a fuel permeability resistance, or a resin tube which is made of only a resin has come to be adopted as the piping tube.

Heretofore, a connection structure as shown in FIGS. 12A and 12B by way of example has been adopted as the connection structure of such a tube for the fuel tank.

Referring to FIG. 12A, numeral 200 designates a fuel tank made of a resin, and numeral 202 a welding joint similarly made of a resin. The welding joint 202 is integrated to the fuel tank 200 by thermal fusion welding.

The welding joint 202 includes a cylindrical portion 204 being a tube fitting portion, and it is provided with an annular flange portion 206 which protrudes from the outer peripheral surface of the cylindrical portion 204.

Numeral 208 designates a resin tube for introducing fuel poured from a filler opening into the fuel tank 200. As shown in FIG. 12B, the resin tube 208 is provided with a bellows portion 210 in order to afford a flexibility.

Referring to FIGS. 12B and 13, numeral 212 designates a quick connector, through which the resin tube 208 is connected to the welding joint 202.

The quick connector 212 is constituted by a connector main body 214 made of a resin, and a retainer 216 similarly made of a resin.

The connector main body 214 includes a nipple portion 218 on one side in the axial direction thereof, and also includes on the other side a socket-like retainer holding portion 230 which holds the retainer 216 that is elastically inserted thereinto.

The nipple portion 218 is a portion onto which the resin tube 208 is press-fitted in an externally fit state so as to fix this resin tube. This nipple portion 218 is formed at its outer peripheral surface with a coming-off preventive portion which has a plurality of annular protrusions 232 at axial intervals, and whose section is in a saw-tooth shape. Besides, a plurality of O-rings (seal rings) 234 are held on the inner peripheral side of the nipple portion 218.

On the other hand, the socket-like retainer holding portion 230 is provided with a recess 236 in a circular arc shape, and a partial ring-shaped portion 238 in a corresponding circular arc shape.

The retainer 216 is elastically deformable in its radial direction as a whole. This retainer 216 includes a circular arc-shaped groove 240 into which the partial ring-shaped portion 238 in the retainer holding portion 230 is elastically fitted, a tapered guide surface 242 which serves to guide the axial insertion of the flange portion 206 on the side of the welding joint 202 and to elastically enlarge the diameter of the whole retainer 216, and a circular arc-shaped engagement recess 244 into which the flange portion 206 is engaged.

With this connection structure, the end part of the resin tube 208 is forcibly press-fitted onto the nipple portion 218 of the connector main body 214, thereby to be fixed.

In that case, the end part of the resin tube 208 is deformed with its diameter enlarged as shown in FIG. 12B, owing to the press fit onto the nipple portion 218, thereby to tighten the nipple portion 218 in the radial direction of the connector main body 214 by a strong tightening force.

Owing to the tightening force and the biting action of the annular protrusions 232 provided in the nipple portion 218, the end part of the resin tube 208 is fixed to the connector main body 214.

The retainer 216 is attached to and held by the connector main body 214, and in that state, the connector 212 is externally fitted on the cylindrical portion 204 of the welding joint 202.

On this occasion, the retainer 216 held by the connector main body 214 is elastically deformed with its diameter enlarged, by the flange portion 206. When the flange portion 206 has reached the engagement recess 244, the retainer 216 is elastically deformed again with its diameter reduced, whereby the flange portion 206 and the engagement recess 244 become an engaged state.

Simultaneously, that part of the cylindrical portion 204 which lies on the distal end side thereof with respect to the flange portion 206 becomes fitted in the O-rings 234 on the inner peripheral side of the connector main body 214, whereby hermetic sealing is established between the cylindrical portion 204 and the connector main body 214.

Meanwhile, unlike the above connection structure, it has been conceived to directly fit and connect the resin tube 208 onto and with the cylindrical portion 204 of the welding joint 202 without the intervention of the quick connector.

Anyway, in a case where the connection portion for the tube is constructed by fusion-welding and integrating the resin-made welding joint to the resin-made fuel tank, problems as stated below are inherent.

Heretofore, an HDPE (high-density polyethylene) resin has been employed as the outer layer material of the fuel tank. Accordingly, the welding joint to be integrated with the fuel tank is required to be fusion-weldable to this fuel tank.

It is considered that, for the purpose of the fusion welding, the whole welding joint including the cylindrical portion is constructed of the HDPE resin of the identical material. However, although the HDPE resin has an excellent fusion-weldability to the fuel tank, it exhibits an insufficient fuel-permeability resistance to incur the problem that fuel permeates out of the welding joint.

As another problem, the HDPE is not sufficient in the point of sag resistance, and when this HDPE has undergone a strong tightening force from the piping tube such as the resin tube, it is liable to plastic deformation and permanent strain, and the coming-off preventive force or sealability of the tube is apprehended to lower with the passage of time.

Also in the case of the connection where the quick connector is connected to the HDPE-made welding joint formed with the flange portion and where the flange portion is engaged with the retainer (engagement portion) of the quick connector, there occurs the problem that the coming-off preventive force is insufficient.

With the object of solving the problem of the fuel permeability resistance, JP-A-2002-254938 discloses that a welding joint is constructed by stacking in its radial direction, a first portion which has a fusion-weldability with the fuel tank, and a second portion which is made of a resin material having a fuel permeability resistance (barrier ability).

FIG. 14 shows an example of the welding joint.

Referring to FIG. 14, numeral 246 designates a resin-made fuel tank, which is constructed by stacking an outer layer 246a and an inner layer 246b made of the HDPE resin, and a barrier layer 246c made of an EVOH (ethylene-vinylalcohol copolymer) resin of excellent fuel-permeability resistance.

Numeral 248 designates a resin-made welding joint which is fusion-welded and integrated to the fuel tank 246. The welding joint 248 includes a cylindrical portion 252 serving as a connection portion (fitting portion) for a tube 258, and a fusion-welded portion 250 being the base end part of this welding joint, and it has the fusion-welded portion 250 fixed to the fuel tank 246 by thermal fusion welding.

The cylindrical portion 252 includes an outer layer 254 and an inner layer 256 which are made of different resin materials. More specifically, the outer layer 254 is made of the same resin material as that of the fusion-welded portion 250, and the inner layer 256 is made of a barrier material, such as PA (polyamide) resin, which is superior in fuel permeability resistance to the resin material of the outer layer 254.

Incidentally, numeral 260 designates a hose band which clamps the tube 258 in a fitted state.

In the welding joint 248 of this structure, when the outer layer 254 in the cylindrical portion 252 and the fusion-welded portion 250 are made of the HDPE resin of the identical material which is highly fusion-weldable to the fuel tank 246, this HDPE resin exhibits an insufficient fuel-permeability resistance (therefore, the inner layer 256 of the cylindrical portion 252 is made of the barrier material in the welding joint 248 shown in FIG. 14). Accordingly, even if a fuel permeability resistance can be ensured for the cylindrical portion 252, the fusion-welded portion 250 made of the HDPE resin is, so to speak, in a “bare state”, and the problem is inherent that fuel within the fuel tank 246 permeates out through the fusion-welded portion 250.

Besides, in the welding joint 248 of the structure shown in FIG. 14, ordinarily the inner layer 256 as well as the outer layer 254 and the fusion-welded portion 250 are integrally molded by two color injection molding. When the welding joint 248 is constructed of a plurality sorts of materials in this manner, there is inherent problem that processes for the molding increase, and thus a cost inevitably rises correspondingly.

The invention has been made for solving such problems.

Incidentally, P JP-A-2002-241546 is a prior art.

JP-A-2002-241546 discloses the technique which alloys an EVOH (ethylene-vinylalcohol copolymer) with polyolephin.

### SUMMARY OF THE INVENTION

The present invention has the above circumstances as its background, and has for its object to provide a welding joint which can favorably solve the problem of fuel permeation from a fusion-welded portion.

Another object is to lower a cost by heightening the moldability of a fusion-welded portion and a cylindrical portion in a welding joint.

Still another object is to prevent a coming-off preventive force from lowering with the passage of time, by heightening sag resistance of a coming-off preventive portion for a tube.

A further object is to prevent fuel within a fuel tank from permeating out through the opening and outer layer of the fuel tank.

According to a first aspect of the invention, there is provided a welding joint including: a cylindrical portion being a connection portion; and an annular fusion-welded portion disposed at a base end part of the cylindrical portion, the fusion-welded portion being configured to be thermal fusion welded to a resin-made fuel tank; wherein at least parts of the fusion-welded portion and the cylindrical portion are integrally molded by employing a resinous alloy material in which a modified high-density polyethylene obtained by introducing a functional group of high affinity to a hydroxyl group of ethylene-vinylalcohol copolymer is alloyed with the ethylene-vinylalcohol copolymer singly or together with high-density polyethylene.

According to a second aspect of the invention, the fusion-welded portion and the cylindrical portion are wholly constructed by employing the single resinous alloy material.

According to a third aspect of the invention, the fusion-welded portion is constituted by a first portion which employs the resinous alloy material, and a second portion which is molded integrally with the first portion, and which employs a resin different from the material of the first portion and having a fusion-weldability to the fuel tank, and the first portion and the second portion are both fusion-welded to the fuel tank.

According to a fourth aspect of the invention, the second portion is constructed of the resinous alloy material, and a ratio of high-density polyethylene/ethylene-vinylalcohol copolymer in the second portion is higher than in the first portion.

According to a fifth aspect of the invention, the welding joint further includes a coming-off preventive portion disposed on an outer peripheral surface of the cylindrical portion to prevent a connected member from coming off the welding joint, and an outer layer including the coming-off preventive portion is constructed of a high-strength resin of excellent sag resistance.

According to a sixth aspect of the invention, the welding joint further includes a highly barrierable layer which employs a resin being superior in fuel permeability resistance to the resinous alloy material and which is provided as an inner layer of the cylindrical portion.

According to a seventh aspect of the invention, the fusion-welded portion is fusion-welded to an end face of the fuel tank around an opening of the fuel tank, the fuel tank having an intermediate layer made of ethylene-vinylalcohol copolymer.

According to an eighth aspect of the invention, the welding joint further includes an extension portion which protrudes inwardly of the fuel tank oppositely to the cylindrical portion through an opening of the fuel tank, which is connected by fusion welding to a resin-made casing arranged within the fuel tank, and which employs a resin being superior in fusion-weldability to the casing to the resinous alloy material.

As described above, according to the invention at least parts of a fusion-welded portion and a cylindrical portion are integrally molded by employing a resinous alloy material in which a modified HDPE (high-density polyethylene) obtained by introducing a functional group of high affinity to a hydroxyl group of EVOH (ethylene-vinylalcohol copolymer) is alloyed with the EVOH singly or together with HDPE free from such a functional group.

The EVOH has heretofore been known as a material of excellent gas barrier ability. The resinous alloy material in which the modified HDPE is alloyed to such EVOH has an excellent fusion-weldability to a fuel tank, owing to the HDPE contained in this alloy material, and it also has a high fuel-permeability resistance (barrier ability) based on the EVOH. In accordance with the invention, accordingly, the problem of the permeation of fuel from the fusion-welded portion to the exterior can be favorably solved while a favorable fusion-welding strength in the fusion-welded portion is held.

Besides, in this invention, at least part of the cylindrical portion being a tube fitting portion is constructed by employing the resinous alloy material, and hence, the problem of the permeation of the fuel from the cylindrical portion to the exterior can also be solved at, at least, the part.

According to the second aspect of the invention, the fusion-welded portion and the cylindrical portion can be wholly constructed by employing the resinous alloy material.

In this way, the fusion-welded portion and the cylindrical portion can be constructed, in effect, of the single resinous alloy material, so that molding processes in the case of molding these portions may be small in number, a moldability is favorable, and a required cost can be lowered.

According to the third aspect of the invention, the fusion-welded portion is constituted by a first portion which employs the resinous alloy material, and a second portion which employs a resin being different from the resinous alloy material and having a fusion-weldability to the fuel tank, and the first portion and the second portion are both fusion-welded to the fuel tank.

In this way, the fusion welding of the first portion employing the resinous alloy material can be reinforced by the fusion welding of the second portion, so that a fusion-welding strength can be effectively heightened.

In this case, also the second portion is constructed of the resinous alloy material, and this second portion can also be constructed by employing the different resinous alloy material in which the ratio of HDPE/EVOH is higher than in the resinous alloy material constructing the first portion (the fourth aspect of the invention). On this occasion, the fusion-welding strength of the second portion becomes higher than that of the first portion, and this fusion-welding strength can be effectively heightened.

Besides, in this case, the second portion is also endowed with an excellent fuel-permeability resistance.

Incidentally, part of the cylindrical portion can also be molded integrally with the first portion by employing the resin which constructs the second portion.

In this way, the contact area between the alloy material constructing the first portion and the resin material constructing the second portion enlarges, and the adhesion strength of the interface between both the portions can be heightened.

According to the fifth aspect of the invention, the outer peripheral surface of the cylindrical portion is provided with a coming-off preventive portion which prevents a connected member from coming off, by biting into the inner peripheral surface of the connected member, and an outer layer including the coming-off preventive portion can be constructed of a high-strength resin of excellent sag resistance such as a PA (polyamide) resin.

In this way, even in a case where a resin tube made of a hard resin is press-fitted and connected onto the cylindrical portion in an externally fit state, the problem can be solved that the coming-off preventive portion undergoes a permanent strain to lower a coming-off preventive force with the passage of time, and a high coming-off preventive force can be maintained over a long term.

According to the sixth aspect of the invention, a highly barrierable layer which employs a resin being higher in fuel permeability resistance than the resinous alloy material can be provided as the inner layer of the cylindrical portion.

In this way, a fuel permeability resistance in the whole welding joint can be heightened still more.

According to the seventh aspect of the invention, the fusion-welded portion is fusion-welded to an end face defining an opening of the fuel tank. In this way, the problem can also be solved that the fuel gas within the fuel tank permeates out through the opening and the outer layer.

According to the eighth aspect of the invention, the welding joint further includes an extension portion which protrudes inwardly of the fuel tank oppositely to the cylindrical portion through an opening of the fuel tank, which is connected by fusion welding to a resin-made casing arranged within the fuel tank, and which employs a resin being superior in fusion-weldability to the casing to the resinous alloy material. In this way, there is attained the advantage that the casing can be easily fusion-welded and integrated to the welding joint.

### BRIEF DESCRIPTION OF THE DRAWINGS

FIG. 1 is a view showing a welding joint according to an embodiment of the present invention;

FIGS. 2A and 2B are perspective views showing essential portions in FIG. 1;

FIG. 3 is a view showing the welding joint in FIG. 1, in a state before fusion welding;

FIGS. 4A to 4C are model diagrams showing the feature of a resinous alloy material employed in the embodiment, in comparison with comparative examples;

FIG. 5A is a view showing another embodiment of the invention;

FIG. 5B is a view showing still another embodiment of the invention;

FIG. 6A is a view showing still another embodiment of the invention;

FIG. 6B is a view showing still another embodiment of the invention;

FIG. 7 is a view showing yet another embodiment of the invention;

FIG. 8 is a view showing a further embodiment of the invention;

FIG. 9A is a view showing a still further embodiment of the invention;

FIG. 9B is a view showing a still further embodiment of the invention;

FIG. 10 is a view showing a yet further embodiment of the invention;

FIG. 11 is a view showing a yet further embodiment of the invention;

FIGS. 12A and 12B are explanatory views showing a conventional connection scheme of a resin tube for a fuel tank;

FIG. 13 is a view showing the individual exploded members of a connection structure in FIG. 12; and

FIG. 14 is a view showing a conventional example of a welding joint.

### DETAILED DESCRIPTION OF THE PREFFERED EMBODIMENT

Now, embodiments of the present invention will be described in detail with reference to the drawings.

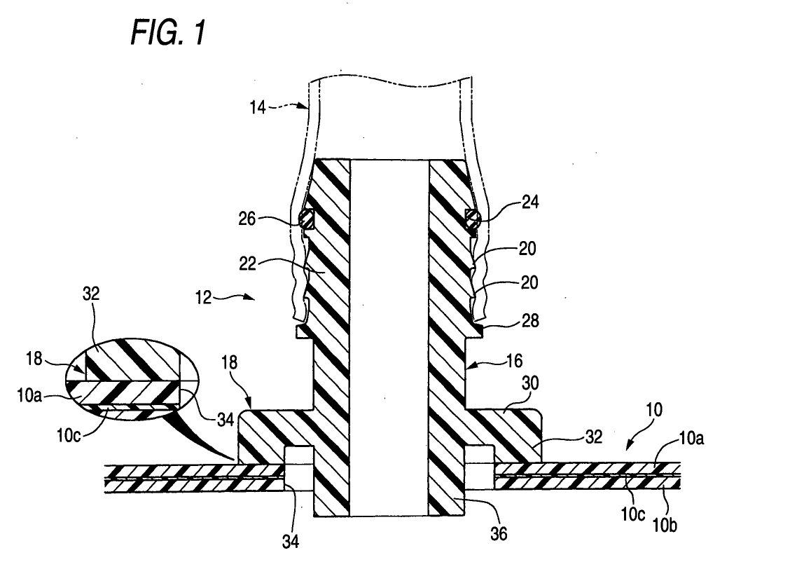

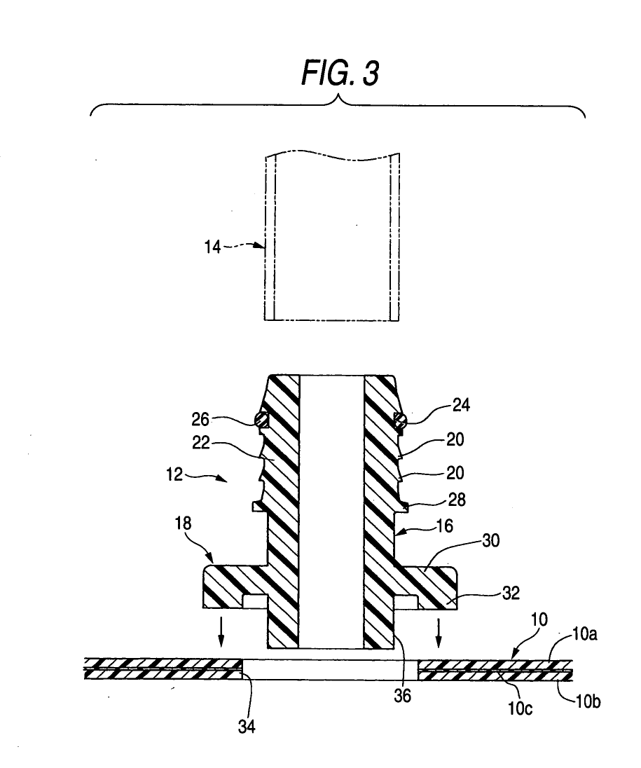

Referring to FIGS. 1 and 3, numeral 10 designates a resin-made fuel tank. Here, the fuel tank 10 forms a stacked structure which consists of an outer layer 10a, an inner layer 10b made of an HDPE resin, and a barrier layer (intermediate layer) 10c being thin.

Here, the barrier layer 10c is made of an EVOH resin which is excellent in fuel permeability resistance.

Numeral 12 designates a resin-made welding joint, which includes a cylindrical portion 16 serving as a connection portion for a piping tube (hereinbelow, simply termed “tube”) 14, and a fusion-welded portion 18 lying at the base end part of this welding joint.

The tube 14 is press-fitted onto the cylindrical portion 16 in an externally fit state, and it is connected to the fuel tank 10 through such a welding joint 12.

The outer peripheral surface of the cylindrical portion 16 is provided with a coming-off preventive portion 22 which has a plurality of annular protrusions 20 at axial intervals, and whose sectional shape is a saw-tooth shape. Besides, an annular groove 24 is formed on the distal end side of the cylindrical portion 16, and a sealing elastic O-ring 26 is accommodated in the annular groove 24.

The O-ring 26 functions to establish sealing between the outer peripheral surface of the cylindrical portion 16 and the inner peripheral surface of the tube 14.

Besides, the coming-off preventive portion 22 functions to prevent the tube 14 from coming off, in such a way that each annular protrusion 20 whose distal end defines an acute angle bites into the inner surface of the tube 14.

The outer peripheral surface of the cylindrical portion 16 is also formed with an annular lug 28 at a position adjacent to the coming-off preventive portion 22 (adjacent position on a base end side).

The annular lug 28 abuts on the distal end of the tube 14, and functions to regulate the fitting quantity of this tube.

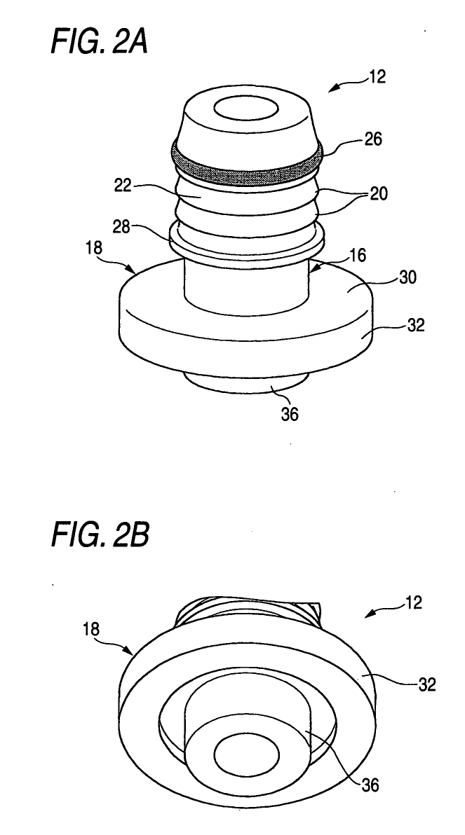

As also shown in FIGS. 2A and 2B, the fusion-welded portion 18 includes a disc-shaped flange portion 30 which extends radially outward from the cylindrical portion 16, and an annular fall portion 32 which falls from the outer peripheral end part of the flange portion 30 toward the fuel tank. At the end face of the fall portion 32, the fusion-welded portion 18 is integrated to the fuel tank 10 at the peripheral edge part of an opening 34 in the fuel tank 10, concretely, at the outer layer 10a by thermal fusion welding.

The welding joint 12 is also provided with an annular extension portion 36 which extends oppositely to the cylindrical portion 16, namely, toward the interior of the fuel tank 10 in the opening 34. Here, the extension portion 36 may well project into the fuel tank 10.

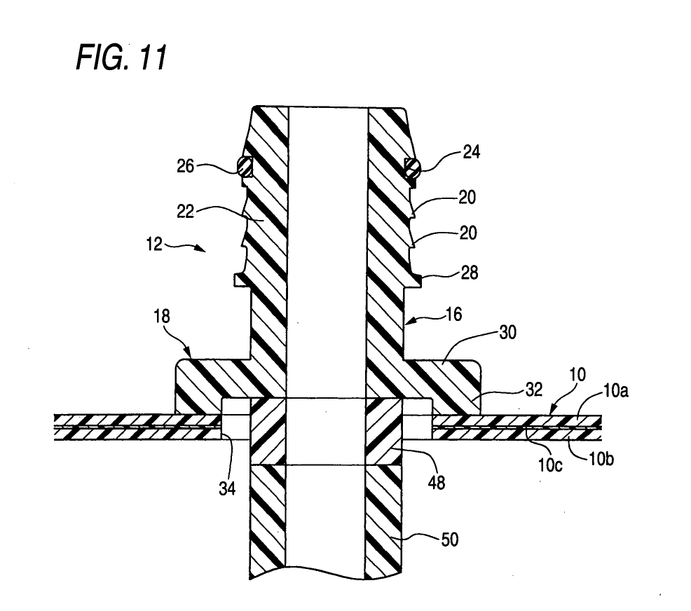

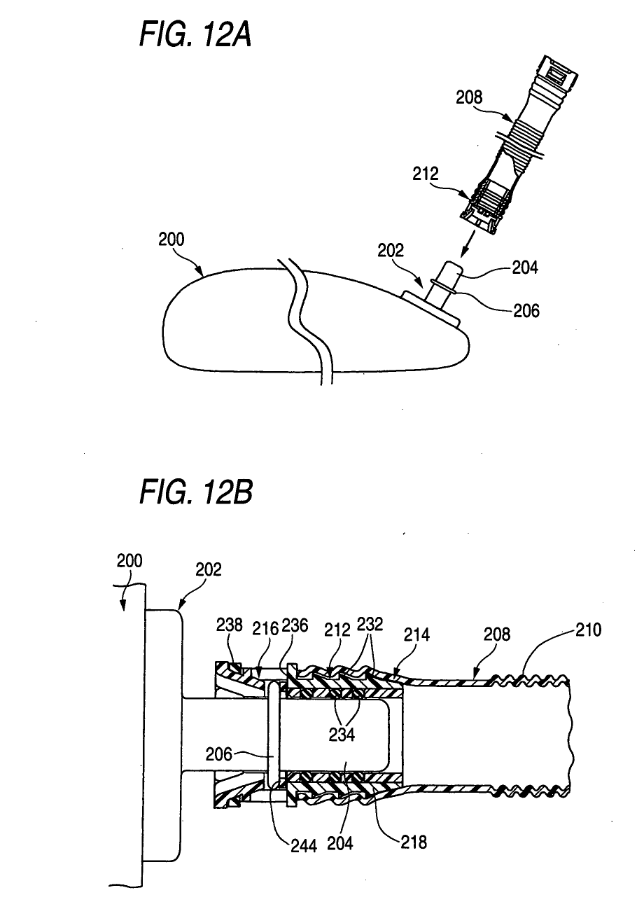

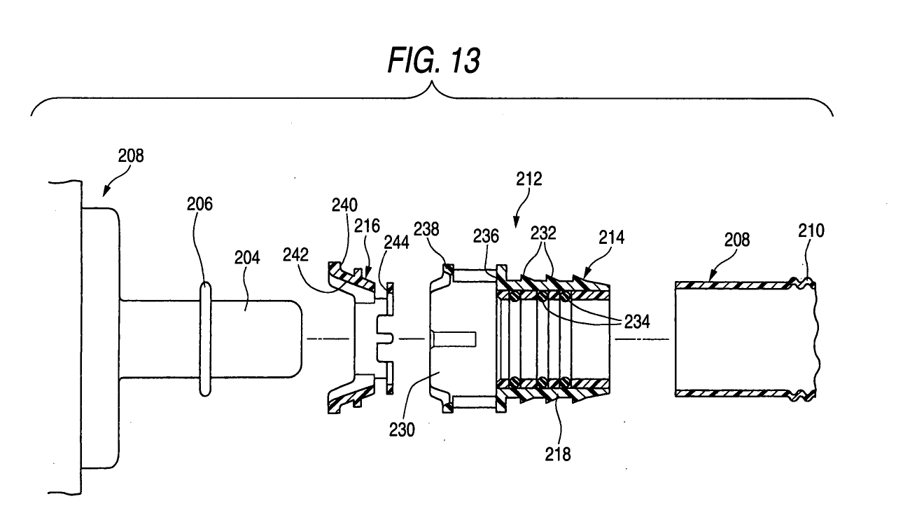

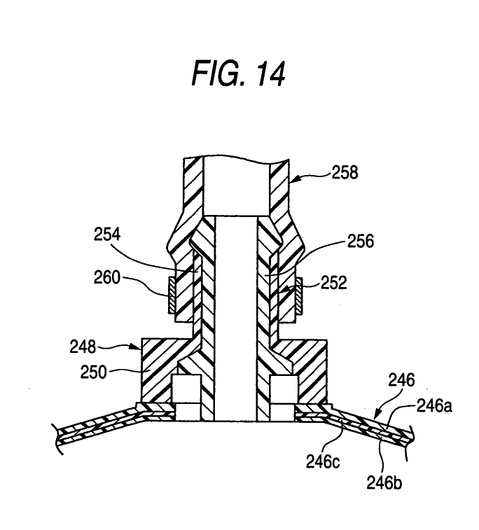

The extension portion 36 is fusion-welded to a cylinder portion 50 (refer to FIG. 11) of a resin-made casing of a valve or the like arranged within the fuel tank 10. This extension portion 36 may well be previously provided with a uneven engagement portion in order to heighten a fusion-weldability to the casing.

In this embodiment, all of the cylindrical portion 16, fusion-welded portion 18 and extension portion 36 in the welding joint 12 are constructed by employing a single resinous alloy material. Specifically, the resinous alloy material here is produced in such a way that modified HDPE (high-density polyethylene) into which a functional group having a high affinity to a hydroxyl group of EVOH (ethylene-vinylalcohol copolymer) is introduced, is alloyed with the EVOH singly or together with ordinary HDPE.

The EVOH has here to fore been known as a material of excellent gas barrier ability. The resinous alloy material in which the modified HDPE is alloyed to such an EVOH has an excellent fusion-weldability to the fuel tank 10, owing to the HDPE contained in this alloy material, and it also has a high fuel-permeability resistance (barrier ability) based on the EVOH. In accordance with this embodiment, accordingly, the problem of the permeation of fuel from the fusion-welded portion 18 to the exterior can be favorably solved while the favorable fusion-welding strength between the fusion-welded portion 18 and the fuel tank 10 is held.

Besides, in this embodiment, all of the fusion-welded portion 18, the cylindrical portion 16 and the extension portion 36 are constructed by employing the single resinous alloy material, so that molding processes in the case of molding these portions may be small in number, a moldability is favorable, and a required cost can be lowered.

Moreover, in this embodiment, the cylindrical portion 16 itself is constructed of the resinous alloy material being excellent in the fuel permeability resistance, so that the permeation of the fuel from the cylindrical portion 16 is favorably preventable.

Here, unlike the ordinary HDPE, the modified HDPE is employed as the material to be alloyed with the EVOH, and this is for the following reason:

The ordinary HDPE is scanty of affinity to the EVOH. Accordingly, merely when the ordinary HDPE is intended to be alloyed with the EVOH, the EVOH becomes large bulks in a state where they are partially localized in the HDPE, on account of the nonaffinity between them.

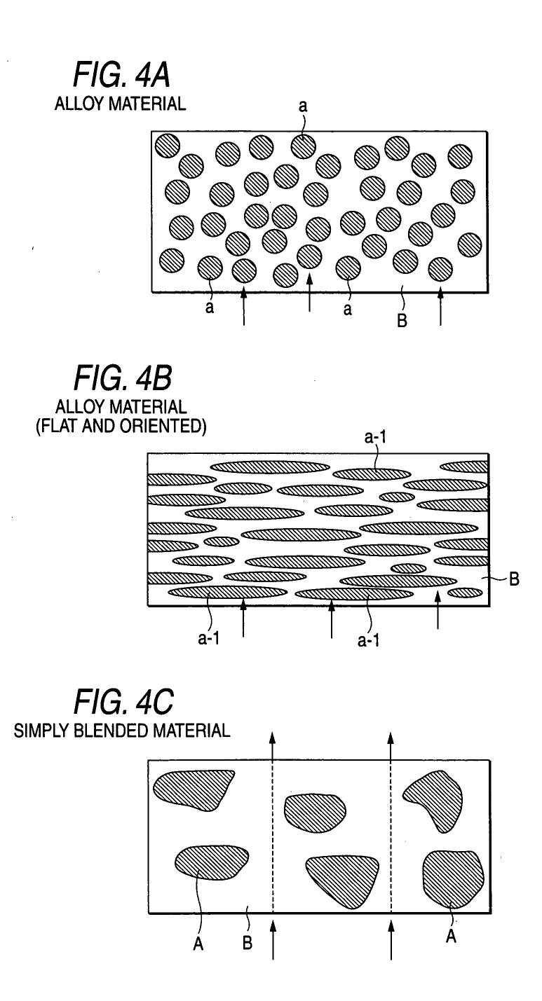

FIG. 4C shows this state in model-like fashion.

In the figure, letter A indicates the large bulks of the EVOH, and letter B indicates the matrix of the HDPE (here, FIG. 4A and FIG. 4B are model diagrams in the case where the HDPE is excessive relative to the EVOH).

In this case, although the EVOH itself is excellent in the fuel permeability resistance, the large bulks A thereof are separate from one another and are localized within the matrix B of the HDPE, so that the fuel gas easily passes among the bulks A of the EVOH and leaks out.

Such a situation is ascribable to the fact that the EVOH and the HDPE are the combination of phase-insoluble materials, so even when both the resins are physically mixed, they give rise to phase separation and form interfaces of low affinity.

As a result, the mixed material (blended material) becomes a state where the bulks of the EVOH are contained as if they were foreign matters. In the state, the mixed material becomes low in strength, and exfoliation is prone to occur at the interfaces between both the resins.

In contrast, in this embodiment, the modified HDPE resin into which the functional group having chemical reactivities (chiefly, hydrogen bonding and covalent bonding) to the hydroxyl group of the EVOH is introduced is employed as the material to be alloyed with the EVOH. As shown in the model diagram of FIG. 4A, therefore, the EVOH becomes small bulks “a” and is evenly dispersed in the matrix of the HDPE (in case of a sea-island structure in which the HDPE forms the sea, while the EVOH forms islands) to establish a state where the EVOH and the HDPE melt together. Accordingly, even when the fuel gas is about to permeate, it collides against the bulks “a” of the EVOH within the resinous alloy material and cannot easily permeate through this resinous alloy material. As a result, the resinous alloy material in this embodiment has a high fuel-permeability resistance (barrier ability).

The reason why the EVOH becomes the minute bulks “a” and is evenly dispersed everywhere within the HDPE in this manner, is that the HDPE has come to exhibit the high affinity to the EVOH, owing to the modification based on the introduction of the functional group.

Moreover, the resinous alloy material shown in FIG. 4A in which the EVOH and the modified HDPE are alloyed heightens in the shock resistance of the material simultaneously with the strength thereof, because the EVOH is dispersed as the small bulks “a”.

Here, examples of the modifying group, namely, the functional group which is introduced into the HDPE, are a carboxyl group, a carbonate-anhydride residual group, an epoxy group, an acrylate group, a methacrylate group, a vinyl acetate group, and an amino group.

Besides, the fusion-welding strength can be heightened by raising the proportion of the HDPE, and the fuel permeability resistance can be enhanced by raising the proportion of the EVOH. Either of the fusion-welding strength and the fuel permeability resistance can be coped with by adjusting the proportion in this manner. As the proportion, the ratio of the EVOH/the modified HDPE is set at 80/20-15/85, preferably 60/40-20/80 in terms of weight.

Besides, it has been described above that the HDPE forms the sea, while the EVOH forms the islands, but the resinous alloy material can also be constructed into a sea-island structure in which conversely the EVOH forms the sea, while the HDPE forms islands.

Further, since any phase-dissolving agent is not contained in the compounding, the resinous alloy material is excellent in the fuel permeability resistance. If necessary, however, a phase-dissolving agent, an inorganic filler or the like may well be compounded in the resinous alloy material. On this occasion, when the phase-dissolving agent is excessively added, the crystallinity of the base material is lowered to increase fuel permeability (to lower barrier ability), so that the phase-dissolving agent is added within a range in which a required barrier performance is ensured.

Besides, apart from alloying the modified HDPE singly with the EVOH, both the ordinary HDPE and the modified HDPE may well be alloyed with the EVOH.

Incidentally, the aspect of existence of the EVOH within the matrix B of the HDPE may well be bulks a-1 whose shape is flat and which are oriented in an identical direction as shown in FIG. 4B. In this case, the fuel permeability resistance is enhanced still more.

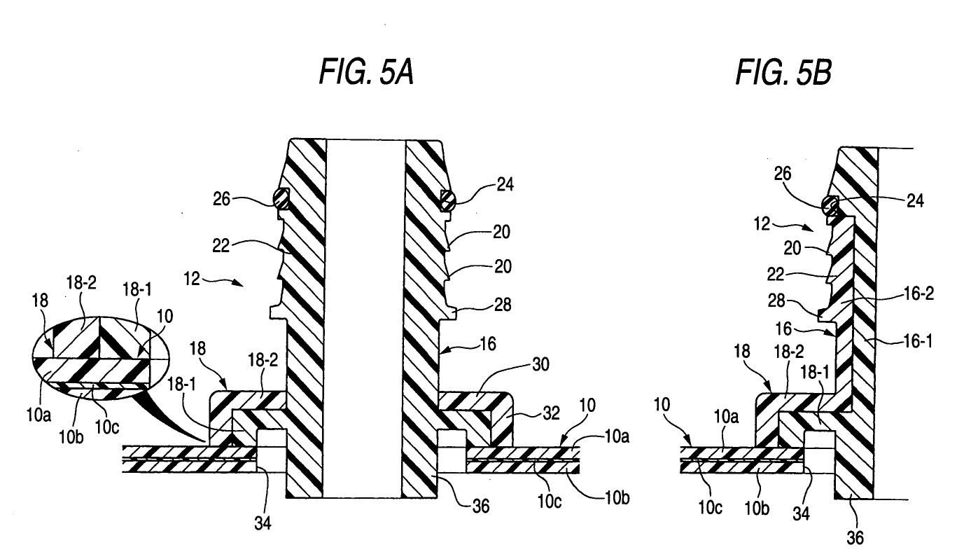

FIG. 5A shows another embodiment of the invention.

This example is such that a fusion-welded portion 18 includes a first portion 18-1 made of the same resinous alloy material as the material of a cylindrical portion 16, and besides, a second portion 18-2 formed on the outer layer side of the first portion 18-1, and that both the first portion 18-1 and the second portion 18-2 are fusion-welded to a resin-made fuel tank 10.

Here, the second portion 18-2 is molded integrally with the others by two color injection molding.

Here, the second portion 18-2 can employ a material which is higher in fusion-welding strength than the first portion 18-1.

In this case, the second portion 18-2 can employ the resinous alloy material consisting of modified HDPE and EVOH, likewise to the first portion 18-1.

On this occasion, however, the ratio of HDPE/EPOH in the resinous alloy material in the second portion 18-2 is set higher than the ratio in the first portion 18-1.

In this embodiment, the second portion 18-2 in the fusion-welded portion 18 employs the resinous material which is higher in the fusion-welding strength than that of the first portion 18-1, so that the fusion welding of the first portion 18-1 can be reinforced by the fusion welding of the second portion 18-2, and the fusion-welding strength can be heightened more effectively.

Besides, in the case where the resinous alloy material consisting of the modified HDPE and the EVOH is employed for the second portion 18-2 and where the HDPE/EVOH ratio of this resinous alloy material is higher than in the first portion 18-1, the fuel permeability resistance of the fusion-welded portion 18 can also be heightened in addition to the heightening of the fusion-welding strength.

FIG. 5B shows still another embodiment.

This embodiment is an example in which a second portion 18-2 in a fusion-welded portion 18 is directly extended to the side of a cylindrical portion 16, and a second portion 16-2 forming the outer layer of the cylindrical portion 16 is integrally constructed of the same material as that of the second portion 18-2 in the fusion-welded portion 18, by two color injection molding.

Incidentally, the second portion 16-2 does not reach the distal end of the cylindrical portion 16, and this second portion 16-2 and a first portion 16-1 define an annular groove 24, in which an O-ring 26 is accommodated.

The second portion 16-2, however, may well be constructed having a length enough to reach the distal end of the cylindrical portion 16.

In this embodiment, the contact area between the whole first portions 18-1, 16-1 and the whole second portions 18-2, 16-2, namely, between different materials enlarges to bring forth the advantage that the adhesion strength of the interface between the first portions and the second portions is heightened.

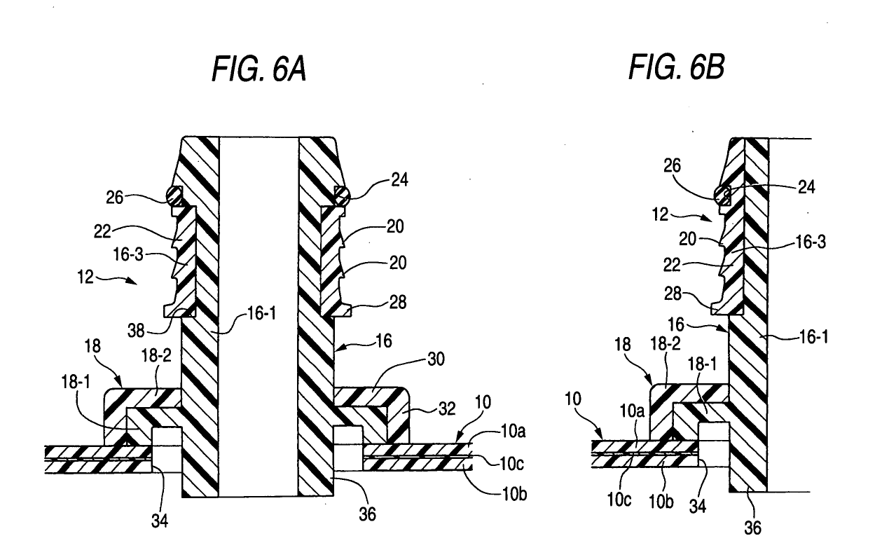

FIG. 6A shows yet another embodiment. This example is such that part of an outer layer in a cylindrical portion 16 is constructed of a PA resin being excellent in sag resistance, that the part is used as a second portion 16-3 in the cylindrical portion 16, and that a coming-off preventive portion 22 is formed in the second portion 16-3.

Here, the second portion 16-3 is in the shape of a circular ring, and it is molded in a state where it is buried in a corresponding circular-ring-shaped recess 38 formed in a first portion 16-1.

Incidentally, the second portion 16-3 may well be constructed having a length enough to reach the distal end of the cylindrical portion 16, as shown in FIG. 6B.

With these embodiments, even in a case where a resin tube made of a hard resin is press-fitted as the tube 14 and connected onto the cylindrical portion 16 in an externally fit state, the problem does not especially occur that the coming-off preventive portion 22 undergoes a permanent strain to lower a coming-off preventive force with the passage of time, and the advantage is attained that a high coming-off preventive force can be maintained over a long term.

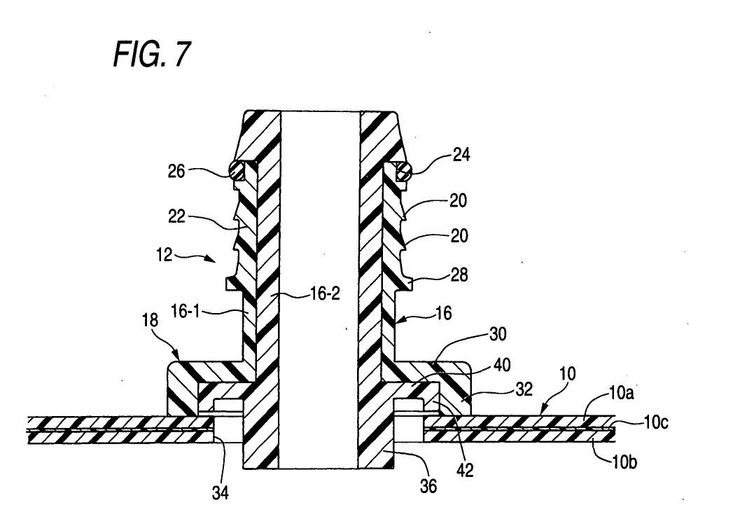

FIG. 7 shows a further embodiment of the invention.

This embodiment is an example in which an inner layer in a cylindrical portion 16 is constructed as a second portion 16-2 by employing a PA resin which is excellent, not only in sag resistance, but also in fuel permeability resistance.

That is, also in this embodiment, the cylindrical portion 16 is constructed as a stacked structure which consists of a first portion 16-1 forming an outer layer, and the second portion 16-2 forming the inner layer.

Incidentally, this embodiment is the same as in the above embodiment in the point that the second portion 16-2 is molded integrally with the first portion 16-1 by two color injection molding.

Besides, in this embodiment, a disc-shaped flange portion 40 and a fall portion 42 falling downwards from the outer peripheral part of the flange portion 40 are integrally molded on the base end side of the second portion 16-2 by employing an identical PA resin, and they are integrally jointed to the inner surface of a fusion-welded portion 18 made of a resinous alloy material.

However, the flange portion 40 and the fall portion 42 are not fusion-welded to a fuel tank 10 and accordingly constitute none of the fusion-welded portion 18.

The fall portion 42 has its distal end retracted above in the figure, with respect to the distal end of a fall portion 32 in the fusion-welded portion 18, and a predetermined gap is defined between the distal end of the fall portion 42 and the fuel tank 10.

In this embodiment, a place where fuel gas within the fuel tank 10 can pass through a welding joint 12 and permeate out is limited to the slight gap between the fuel tank 10 and the distal end of the fall portion 42 at the outer peripheral part of the flange portion 40 formed in the second portion 16-2. Moreover, in this embodiment, the fusion-welded portion 18 itself has a fuel permeability resistance. Therefore, the permeation of the fuel through the fusion-welded portion 18 can be suppressed more effectively.

Besides, in this embodiment, also the cylindrical portion 16 has its inner layer constructed of the PA resin which is a highly barrierable material of excellent fuel-permeability resistance. Therefore, the permeation of the fuel from the cylindrical portion 16 can also be suppressed more effectively.

By the way, in the embodiment in FIG. 7, the second portion 16-2 can employ a highly barrierable material other than the PA resin.

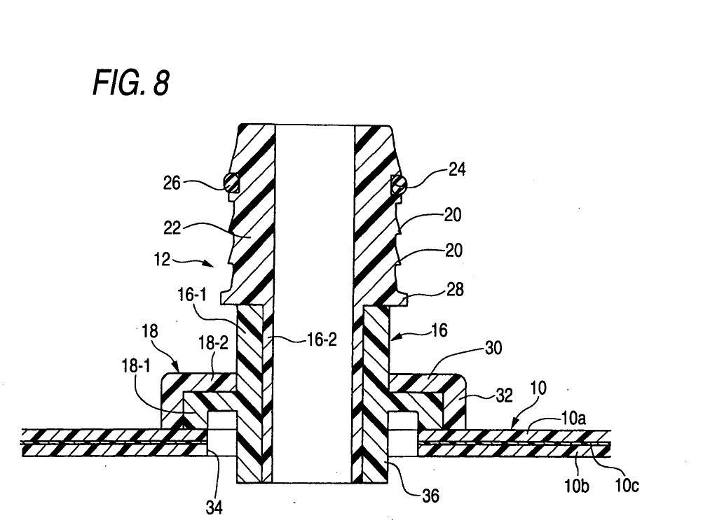

FIG. 8 shows a still further embodiment of the invention.

This embodiment is an example in which a second portion 16-2 is constructed of a PA resin which is excellent in sag resistance and fuel permeability resistance, the inner layer of a cylindrical portion 16 being substantially a lower half part in the figure, and the whole distal end side of the cylindrical portion 16 being substantially an upper half part are constructed by the second portion 16-2, and a coming-off preventive portion 22 is provided in the second portion 16-2.

In this embodiment, the second portion 16-2 can more heighten the fuel permeability resistance in the cylindrical portion 16 and can conjointly heighten the sag resistance of the coming-off preventive portion 22, so that the lowering of the coming-off preventive force of the tube 14 with the passage of time is preventable more favorably.

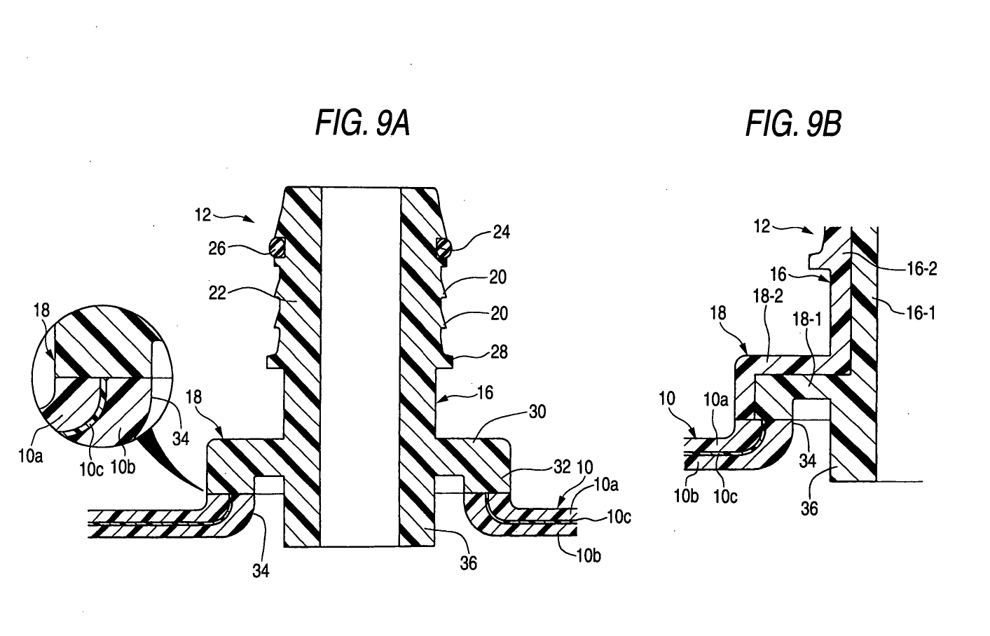

FIGS. 9A and 9B show a yet further embodiment of the invention.

An example shown in FIG. 9A is such that, in the embodiment in FIG. 1, the outer layer 10a and inner layer 10b of the HDPE resin and the barrier layer 10c of the EVOH resin in the fuel tank 10 are respectively bent upwards in the figure, at the peripheral edge part of the opening 34, whereupon the end faces of the layers 10a, 10b and 10c are exposed upwards so as to thermally fusion-weld the fusion-welded portion 18 (in a state before fusion welding) to the end faces.

Besides, an example shown in FIG. 9B is such that, in the embodiment in FIG. 5B, the outer layer 10a, inner layer 10b and barrier layer 10c at the peripheral edge part of the opening 34 in the fuel tank 10 are similarly bent upwards, whereupon the end faces of the layers are exposed upwards so as to thermally fusion-weld the fusion-welded portion 18 (in a state before fusion welding) to the end faces.

In this way, the problem can also be solved that fuel gas within the fuel tank 10 permeates out through the opening 34 and the outer layer 10a.

More specifically, in each of the embodiments mentioned above, the permeation of the fuel from the fusion-welded portion 18 itself is preventable, but the fuel gas within the fuel tank 10 is still apprehended to permeate from the opening 34 through the outer layer 10a in the fuel tank 10 itself. In contrast, according to the embodiment shown in FIGS. 9A and 9B, such a problem can also be solved.

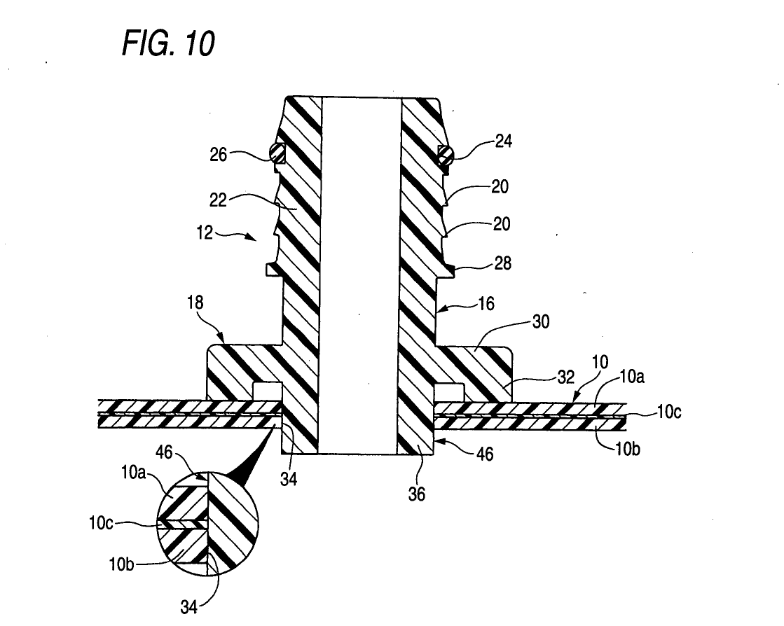

FIG. 10 shows yet further embodiment of the invention.

This embodiment is an example in which, in the embodiment shown in FIG. 1, the respective end faces of the outer layer 10a, inner layer 10b and barrier layer 10c in the fuel tank 10 are exposed at the peripheral surface of the opening 34, while the extension portion 36 is used as a second fusion-welded portion 46, so as to fusion-weld the outer peripheral surface of the fusion-welded portion 46 to the peripheral surface of the opening 34 of the fuel tank 10, that is, the end faces of the outer layer 10a, inner layer 10b and barrier layer 10c.

Also this embodiment can solve the problem that fuel gas within the fuel tank 10 permeates out through the opening 34 and the outer layer 10a of the fuel tank 10.

FIG. 11 shows a yet further embodiment of the invention.

This embodiment is such that a cylindrical connection portion 48 which protrudes inwardly of a fuel tank 10 oppositely to a cylindrical portion 16, in the opening 34 of the fuel tank 10, and which is to be connected by fusion welding to the cylinder portion 50 of the resin-made casing of a valve or the like arranged within the fuel tank 10 is previously molded integrally with a fusion-welded portion 18 and the cylindrical portion 16 by two color injection molding, and that the cylinder portion 50 of the casing is connected to the cylindrical connection portion 48 by the fusion welding.

In general, the casing is constructed of a PA resin, and the PA resin can accordingly be suitably employed as the material of the connection portion 48. It is also possible, however, to employ the modified HDPE resin stated before.

In this way, a fusion-welding strength can be heightened more than in the case where the cylindrical extension portion 36 made of the resinous alloy material is provided downwards, and where the cylinder portion 50 of the casing is directly fusion-welded to the extension portion 36.

Incidentally, a resin material of which the connection portion 48 is made can be appropriately selected in accordance with the material properties of the resin for making the cylinder portion 50 of the casing, and so on.

Anyway, a resin material the fusion-weldability of which to the cylinder portion 50 of the casing is superior to that of the resinous alloy material for making the fusion-welded portion 18 and the cylindrical portion 16 is employed for the connection portion 48.

Although the embodiments of the invention have been detailed above, the invention is not limited as herein described, and the invention can be constructed in various altered aspects within a scope not departing from the purport thereof.

What is claimed is:

1. A welding joint comprising:
a cylindrical portion being a connection portion; and
an annular fusion-welded portion disposed at a base end part of the cylindrical portion, the fusion-welded portion being configured to be thermal fusion welded to a resin-made fuel tank;
wherein at least parts of the fusion-welded portion and the cylindrical portion are integrally molded by employing a resinous alloy material in which a modified high-density polyethylene obtained by introducing a functional group of high affinity to a hydroxyl group of ethylene-vinylalcohol copolymer is alloyed with the ethylene-vinylalcohol copolymer.

2. The welding joint according to claim 1, wherein the fusion-welded portion and the cylindrical portion are wholly constructed by employing the single resinous alloy material.

3. The welding joint according to claim 1, wherein the fusion-welded portion is constituted by a first portion which employs the resinous alloy material, and a second portion which is molded integrally with the first portion, and which employs a resin different from the material of the first portion and having a fusion-weldability to the fuel tank, and the first portion and the second portion are both fusion-welded to the fuel tank.

4. The welding joint according to claim 3, wherein the second portion is constructed of the resinous alloy material, and a ratio of high-density polyethylene/ethylene-vinylalcohol copolymer in the second portion is higher than in the first portion.

5. The welding joint according to claim 1, further comprising a coming-off preventive portion disposed on an outer peripheral surface of the cylindrical portion to prevent a connected member from coming off the welding joint, and an outer layer including the coming-off preventive portion is constructed of a high-strength resin of excellent sag resistance.

6. The welding joint according to claim 1, further comprising a highly barrierable layer which employs a resin being superior in fuel permeability resistance to the resinous alloy material and which is provided as an inner layer of the cylindrical portion.

7. The welding joint according to claim 1, wherein the fusion-welded portion is fusion-welded to an end face of the fuel tank around an opening of the fuel tank, the fuel tank having an intermediate layer made of ethylene-vinylalcohol copolymer.

8. The welding joint according to claim 1, further comprising an extension portion which protrudes inwardly of the fuel tank oppositely to the cylindrical portion through an opening of the fuel tank, which is connected by fusion welding to a resin-made casing arranged within the fuel tank, and which employs a resin being superior in fusion-weldability to the casing to the resinous alloy material.

9. A welding joint comprising:
a cylindrical portion being a connection portion; and
an annular fusion-welded portion disposed at a base end part of the cylindrical portion, the fusion-welded portion being configured to be thermal fusion welded to a resin-made fuel tank;
wherein at least parts of the fusion-welded portion and the cylindrical portion are integrally molded by employing a resinous alloy material in which a modified high-density polyethylene obtained by introducing a functional group of high affinity to a hydroxyl group of ethylene-vinylalcohol copolymer is alloyed with the ethylene-vinylalcohol copolymer together with high-density polyethylene.

10. The welding joint according to claim 9, wherein the fusion-welded portion and the cylindrical portion are wholly constructed by employing the single resinous alloy material.

11. The welding joint according to claim 9, wherein the fusion-welded portion is constituted by a first portion which employs the resinous alloy material, and a second portion which is molded integrally with the first portion, and which employs a resin different from the material of the first portion and having a fusion-weldability to the fuel tank, and the first portion and the second portion are both fusion-welded to the fuel tank.

12. The welding joint according to claim 11, wherein the second portion is constructed of the resinous alloy material, and a ratio of high-density polyethylene/ethylene-vinylalcohol copolymer in the second portion is higher than in the first portion.

13. The welding joint according to claim 9, further comprising a coming-off preventive portion disposed on an outer peripheral surface of the cylindrical portion to prevent a connected member from coming off the welding joint, and an outer layer including the coming-off preventive portion is constructed of a high-strength resin of excellent sag resistance.

14. The welding joint according to claim 9, further comprising a highly barrierable layer which employs a resin being superior in fuel permeability resistance to the resinous alloy material and which is provided as an inner layer of the cylindrical portion.

15. The welding joint according to claim 9, wherein the fusion-welded portion is fusion-welded to an end face of the fuel tank around an opening of the fuel tank, the fuel tank having an intermediate layer made of ethylene-vinylalcohol copolymer.

16. The welding joint according to claim 9, further comprising an extension portion which protrudes inwardly of the fuel tank oppositely to the cylindrical portion through an opening of the fuel tank, which is connected by fusion welding to a resin-made casing arranged within the fuel tank, and which employs a resin being superior in fusion-weldability to the casing to the resinous alloy material.
